(19) United States
(12) Patent Application Publication
(10) Pub. No.: US 2016/0052712 A1
(43) Pub. Date: Feb. 25, 2016

(54) Apparatus and method for dispensing unused animal waste bag and carrying used animal waste bag

(71) Applicant: JoElla Jackson-Tyree, Charleston, SC (US)

(72) Inventor: JoElla Jackson-Tyree, Charleston, SC (US)

(21) Appl. No.: 14/121,326

(22) Filed: Aug. 20, 2014

(51) Int. Cl. B65F 1/06; B65F 1/14; E01H 1/12

(52) U.S. Cl. CPC B65F 1/062; E01H 1/1206; B65F 1/14; E01H 2001/1286; E01H 2001/128

(57) ABSTRACT

The present invention discloses a dispenser and carrier for bags, and, more specifically, to a device for use in a method for dispensing unused animal waste bags and also to a device and method for carrying both unused animal waste bags and used animal waste bags. The device may be constructed so as to be either permanently affixed, such as a sewn connection, or removably affixable to a strap, such as a leash.

### CROSS-REFERENCE TO RELATED APPLICATIONS

Not Applicable.

### STATEMENT REGARDING FEDERALLY-SPONSORED RESEARCH OR DEVELOPMENT

Not Applicable.

### BACKGROUND OF THE INVENTION

The present general inventive concept relates generally to a dispenser and carrier for bags, and, more specifically, to a dispenser for dispensing unused animal waste bags and also carrying used animal waste bags. The dispenser is constructed so as to be removably affixable to a strap, such as, for one example, a leash.

### BRIEF DESCRIPTION OF THE DRAWINGS

A wide variety of potential embodiments will become more clearly understood from the following detailed description of certain exemplary embodiments, read together with the accompanying drawings in which:

FIG. 1 is a diagram illustrating an example embodiment of the present general inventive concept in an open position;

FIG. 2 is a diagram illustrating an example embodiment of the present general inventive concept in a closed position;

FIG. 3 is a diagram illustrating an example embodiment of the present general inventive concept in a dosed position and removably affixed to a chain;

FIG. 4 is a diagram illustrating an example embodiment of the present general inventive concept in use;

FIG. 5 is a diagram illustrating an example embodiment of the present general inventive concept in a closed position and removably affixed to a strap.

### DETAILED DESCRIPTION OF THE INVENTION

The following detailed description may recite various descriptive terms such as horizontal, vertical, top, bottom, upward, downward, left, right, etc., when referring to the exemplary figures, but the present general inventive concept is not limited to any such terms or physical orientations. Such terms are used for convenience of description only, and could be reversed, modified, or interchanged without departing from the broader scope and spirit of the present general inventive concept.

The present general inventive concept, in some of its embodiments, can include a chamber having an inner surface, an outer surface, an enclosed bottom and an attached top. In some embodiments, the attached top removably closes upon the outer surface of the chamber. In some exemplary embodiments, the attached top contains an opening integrated into the attached top, such as, for one example, a slit. The outer surface of the chamber can contain at least two attachment points—the first attachment point for removably attaching the apparatus onto a strap, chain, leash, lead line, harness line, or similar device for restraining a pet, and the second attachment point for removably attaching a used animal waste bag to the chamber so as to minimize the need for human interaction with the used animal waste bag, i.e., there is no need to carry the used animal waste bag in one's hand. In some embodiments, the attached top is closeable; in such embodiments, the means of closure can be any of a number of devices (known in the art) such as, for example, a snap, a button, or hook and loop closure material.

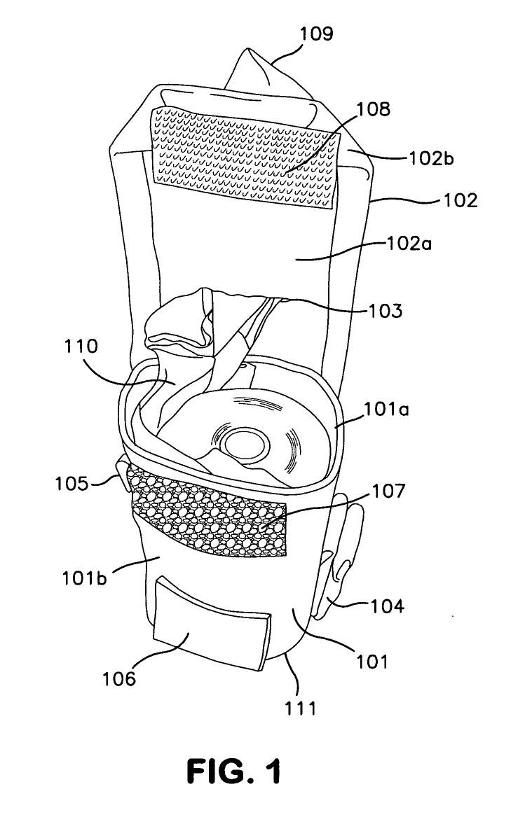

As illustrated in FIG. 1, chamber 101 includes an inner surface 101a and an outer surface 101b, a bottom 111 and a top 102. Top 102 is further defined to have an inner surface 102a and an outer surface 102b. In some embodiments, top 102 is removably attachable to chamber 101, by means known in the art, such as, for one example, hook 107 and loop 108 material. In some embodiments, optional pull tab 109 is attached to top 102 to enhance ease of opening top 102 from chamber 101. In some exemplary embodiments, opening 103 is throughcut through top 102, thus providing a means of threading an individual, unused waste bag off roll 110 of unused waste bags through opening 103 for ready access when top 102 is in a closed (removably attached) position upon outer surface 101b of chamber 101. Clip 105 is attached to outer surface 101b of chamber 101 and provides a means of removably attaching the present general inventive concept to a strap, such as a leash. Clip 104 is attached to outer surface 101b of chamber 101 and provides a means of removably attaching a used waste bag to outer surface 101b chamber 101. Optional panel 106 may be attached to outer surface 101b of chamber 101 to provide ornamentation, such as, for one example, a panel of color contrasting material, or, for another example, a brand logo.

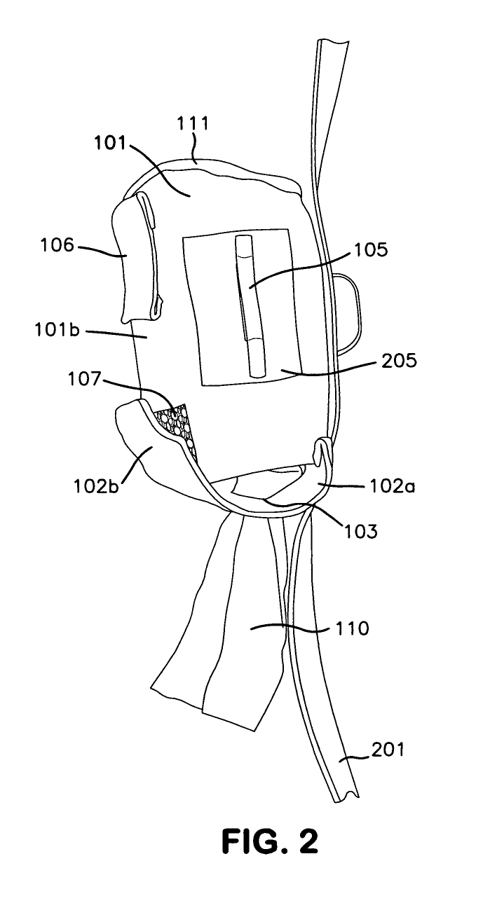

FIG. 2 illustrates an example embodiment of the present general inventive concept in a closed position, where top 102 is removably attached to (closed upon) outer surface 101b of chamber 101. Unused waste bag 110 is threaded through opening 103 for ready dispensing. Clip 105 is ready to attach the present general inventive concept to a strap 201, such as a leash. Optionally, clip 105 may be attached to outer surface 101b of chamber 101 by use of a contrasting patch 205, for ornamental purposes or, alternatively, for reinforced structural integrity and extended wear and use of the device.

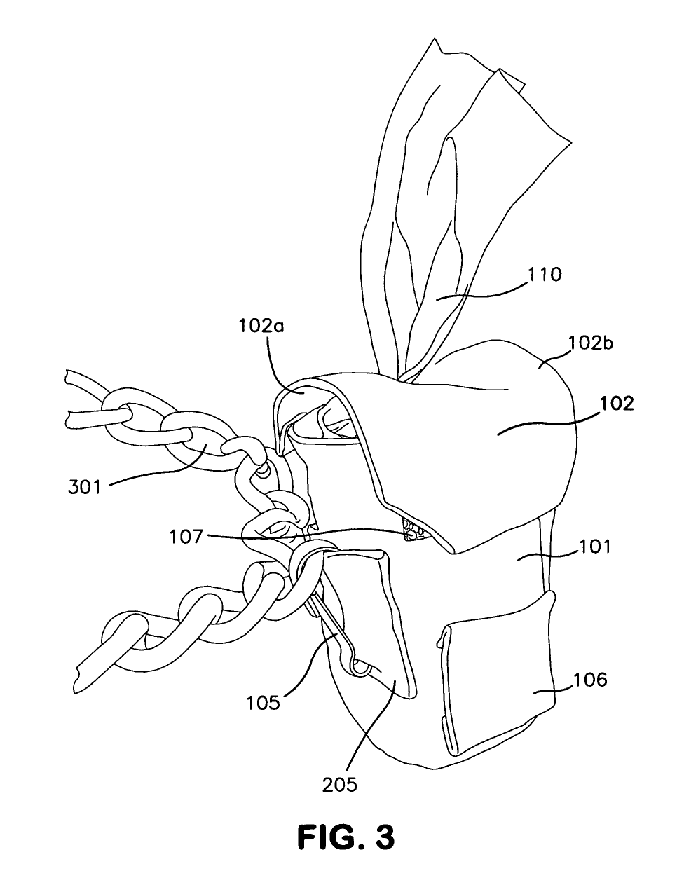

FIG. 3 illustrates an example embodiment of the present general inventive concept in a closed position, where clip 105 is removably attached to a chain 301, such as, for one example, a chain leash. Unused waste bag 110 is exposed via opening 103 (see FIGS. 1 & 2) in top 102 for ease of access.

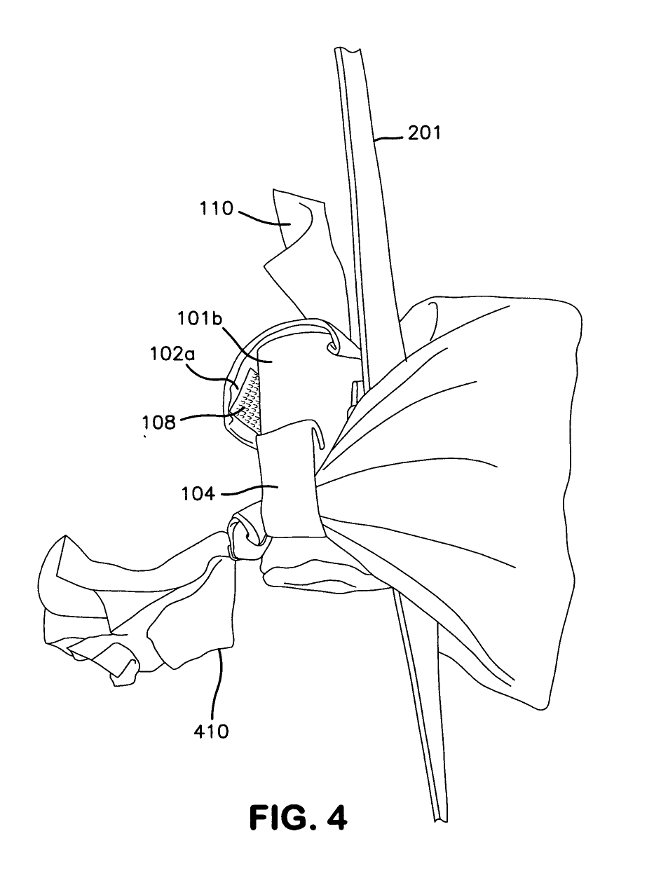

FIG. 4 illustrates an example embodiment of the present general inventive concept in use. Here, the device is removably attached to a strap 201, such as a leash. A used bag 410 can be tied and inserted through clip 104, thus providing a hands-free means of transporting animal waste until such time as proper, permanent disposal is available.

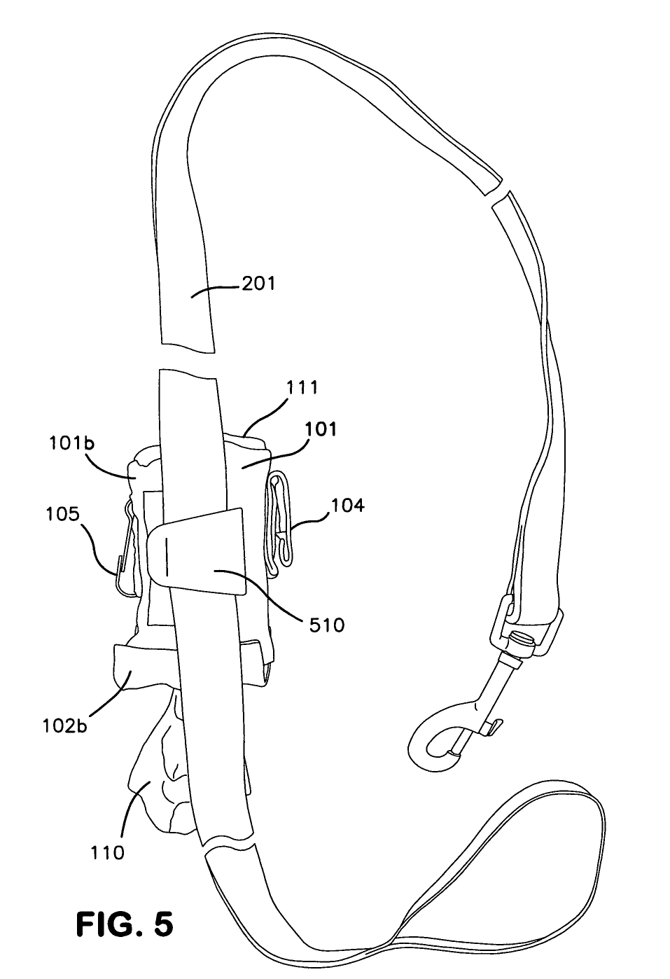

FIG. 5 illustrates illustrating an example embodiment of the present general inventive concept in a closed position and removably affixed to a strap 201, such as leash. Optional additional clip 510 serves to provide a means of attachment between the present general inventive device and strap 201.

Still other embodiments will become readily apparent to those skilled in this art from reading the above-cited detailed description in view of all the drawings. It is noted that the simplified diagrams do not illustrate all the various connections and assemblies of the various components, however, those skilled in the art will understand how to implement such connections and assemblies, based on the illustrated components, figures, and descriptions provided herein.

While the present general inventive concept has been illustrated by description of some embodiments, and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

It is also noted that numerous variations, modifications, and additional embodiments are possible, and, accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Accordingly, while the present general inventive concept has been illustrated by description of several embodiments, it is not the intention of the applicant to restrict or in any way limit the scope of the inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings.

What is claimed is:

1. A device for dispensing unused animal waste bags and carrying used animal waste bags comprising:
(1) a chamber, said chamber defined to have an inner surface, an outer surface, an affixed bottom and a removably attachable top;
(2) a first means to attach said chamber to a strap; and
(3) a second means to removably attach a used waste bag to said chamber for temporary storage of said used waste bag.

2. The device of claim 1, said removably attachable top having further defined therein an opening for removing individual unused waste bags stored in said chamber through said top.

3. The device of claim 1 in which said first means provides a removable attachment to said strap.

4. The device of claim 2 in which said first means provides a removable attachment to said strap.

5. The device of claim 1 in which said first means provides an affixed attachment to said strap.

6. The device of claim 2 in which said first means provides an affixed attachment to said strap.

7. The device of claim 3 in which said first means is a clip.

8. The device of claim 4 in which said first means is a clip.

9. The device of claim 3 in which said second means is a clip.

10. The device of claim 4 in which said second means is a clip.

11. A method for dispensing unused animal waste bags and carrying used animal waste bags comprising the steps of:
(1) Attaching a dispensing device comprising a chamber defined by an inner surface, an outer surface, an affixed bottom, and a removably attachable top on said strap, via said first means, near a first end of said strap opposed to a second end of said strap attached to an animal, wherein the device chamber carries at least one unused animal waste bag;
(2) Removing said unused animal waste bag from said device chamber and inserting animal waste into said unused animal waste bag, converting said bag into a used animal waste bag; and
(3) Removably attaching said used animal waste bag to said strap, via said second means, for hands-free storage of said used animal waste bag for subsequent, more permanent disposal.

12. The method of claim 11 wherein said removably attachable top is attached to said chamber in a manner to provide, alternatively, access to and closure of said chamber.

13. The method of claim 11 wherein said first means provides a removable attachment to said strap.

14. The method of claim 12 wherein said first means provides a removable attachment to said strap.

15. The method of claim 11 wherein said first means provides an affixed attachment to said strap.

16. The method of claim 12 wherein said first means provides an affixed attachment to said strap.

17. The method of claim 13 wherein said first means is a clip.

18. The method of claim 14 wherein said first means is a clip.

19. The method of claim 13 wherein said second means is a clip.

20. The method of claim 14 wherein said second means is a clip.

21. The method of claim 15 wherein said first means is provided by a sewn attachment.

22. The method of claim 16 wherein said first means is provided by a sewn attachment.

23. The method of claim 15 wherein said second means is a clip.

24. The method of claim 16 wherein said second means is a clip.
